(19) United States
(12) Patent Application Publication
(10) Pub. No.: US 2026/0202069 A1
(43) Pub. Date: Jul. 16, 2026

(54) SPRAY REFRIGERATION FAN

(71) Applicant: Guangdong Weiteshijia Technology Co., Ltd., Huizhou (CN)

(72) Inventor: Caixia Zhu, Shenzhen (CN)

(21) Appl. No.: 19/564,400

(22) Filed: Mar. 12, 2026

(30) Foreign Application Priority Data
Feb. 9, 2026 (CN) 202620194963.8

(51) Int. Cl. F24F 6/12; F04D 19/00; F04D 25/08

(52) U.S. Cl. CPC F24F 6/12; F04D 19/002; F04D 25/084

(57) ABSTRACT

Provided is a spray refrigeration fan. The spray refrigeration fan includes a blowing part. The blowing part includes an air duct. Two ends of the air duct are arranged as an air inlet and an air outlet, respectively. A water storage tank is arranged around a circumferential wall surface of the air duct. A lower end of the water storage tank is provided with an atomization plate base. The atomization plate base is communicated with an interior of the water storage tank. The atomization plate base is provided with an atomization plate. Water in the water storage tank is converted into water mist and sprayed outward by the atomization plate.

### TECHNICAL FIELD

The present disclosure relates to the technical field of a spray fan, and in particular, to a spray refrigeration fan.

### BACKGROUND

A spray fan refers to a product in which a body of the fan is provided with a spray device, the spray device atomizes water, and then water mist is carried out and diffused outward through air flow generated by the body of the fan, thereby achieving a better cooling effect and increasing humidity of ambient air.

A conventional spray fan uses an ultrasonic atomization plate to atomize liquid water, thereby forming water mist and spraying water mist outward. This requires that a water storage tank should be integrally arranged on a body of the spray fan to provide a water source for operation of the ultrasonic atomization plate without affecting portability. However, in the field of a portable fan, capacity of a water tank may be greatly limited. If the capacity of the water tank is large, appearance of the product may be very ugly and uncoordinated. However, if the water tank is small, the demand for atomization cannot be met, and water needs to be refilled to the water tank frequently. This creates a contradiction between practicality and portability, which has become an urgent problem to be solved by those skilled in the art.

### SUMMARY

An objective of the present disclosure is to provide a spray refrigeration fan. A water storage tank is skillfully arranged around an air duct in a circumferential direction, thereby arranging a large-capacity water tank, meeting an atomization water demand of an atomization device, and also effectively avoiding an adverse effect of the large-capacity water tank on appearance and portability of a product. Problems raised in the above background are solved.

In order to achieve the above objective, the present disclosure provides the following technical solution: a spray refrigeration fan, including a blowing part, where the blowing part includes an air duct, two ends of the air duct are arranged as an air inlet and an air outlet, respectively, a water storage tank is arranged around a circumferential wall surface of the air duct, a lower end of the water storage tank is provided with an atomization plate base, the atomization plate base is communicated with an interior of the water storage tank, the atomization plate base is provided with an atomization plate, and water in the water storage tank is converted into water mist and sprayed outward by the atomization plate.

Preferably, the blowing part includes a housing, the housing includes a tubular air duct, two ends of the air duct are arranged as a first end and a second end, respectively, an edge of the second end of the air duct is turned over 180 degrees toward a circumferential outer side of the air duct and then extends along a length direction of the air duct to form a blowing part shell, the water storage tank is formed between the blowing part shell and an outer wall surface of the air duct, and the water storage tank includes a water tank packaging plate covered at the first end.

Preferably, an outer side of the water tank packaging plate is covered with a modeling decorative surface shell.

Preferably, a wall surface of the water storage tank is provided with a water injection port, and the water injection port is movably covered with a water port cover.

Preferably, a fan blade base is arranged in the air duct, the fan blade base is arranged toward an air inlet side, a part of a body on a circumferential wall surface of the fan blade base radially extends to form an air guide blade, one end that is of the air guide blade and that is far away from the fan blade base is connected with an inner wall surface of the air duct, a driving fan blade assembly is mounted on the fan blade base, the driving fan blade assembly guides air flow at the air inlet to flow through the air duct and then to be blown outward from the air outlet, an electrical base is arranged on one side that is of the fan blade base and that faces away from the driving fan blade assembly, the blowing part is provided with a wiring channel, and the wiring channel is communicated with the electrical base and an outer space of the blowing part.

Preferably, a refrigeration device is mounted on the electrical base, the refrigeration device includes a conducting member, a thermoelectric semiconductor, and a heat dissipating member, the heat dissipating member is fixedly arranged on the electrical base through a mounting bracket, the thermoelectric semiconductor is fixedly arranged on the mounting bracket, the conducting member is mounted on one side that is of the thermoelectric semiconductor and that faces away from the heat dissipating member, the thermoelectric semiconductor includes a heating end and a cooling end, the heating end is in heat conduction connection with the heat dissipating member, and the cooling end is in heat conduction connection with the conducting member.

Preferably, the heat dissipating member is an aluminum alloy member, and the conducting member is a steel metal member.

Preferably, a lower end of the blowing part is connected with a holding part, the holding part includes a holding housing, an accommodating cavity is formed in the holding housing, a circuit board assembly and a storage battery are arranged in the accommodating cavity, the storage battery is electrically connected with the circuit board assembly, the circuit board assembly is electrically connected with a control button and a power interface, and both the control button and the power interface are arranged in a preset through hole of the holding housing and extend outward from the through hole.

Preferably, the holding housing includes handle inner shells and handle outer shells, two handle inner shells are arranged, the two handle inner shells are located at a front side and a rear side, respectively, to cover and connect with each other to form the accommodating cavity, two handle outer shells are arranged, the two handle outer shells are buckled on a left side and a right side of the handle inner shell, respectively, a wall surface of the handle inner shell is provided with a buckling hole, an inner wall surface of the handle outer shell is provided with a buckling claw corresponding to the buckling hole, and the handle outer shell is buckled on the buckling hole through the buckling claw to be integrally connected with the handle inner shell.

Preferably, the air inlet is covered with a hollow air inlet cover.

Compared with the prior art, the present disclosure has the following beneficial effects.

According to the spray refrigeration fan, the water storage tank is skillfully arranged around the air duct in a circumferential direction, thereby arranging a large-capacity water tank, meeting an atomization water demand of an atomization device, and also effectively avoiding an adverse effect of the large-capacity water tank on appearance and portability of a product. In addition, a refrigeration device can also add a cold compress care function to the fan, thereby greatly improving practicability of the fan.

### BRIEF DESCRIPTION OF THE DRAWINGS

FIG. 1 is a first explosion diagram of a structure according to the present disclosure;

FIG. 2 is a second explosion diagram of a structure according to the present disclosure;

FIG. 3 is a third explosion diagram of a structure according to the present disclosure;

FIG. 4 is a first schematic diagram of an appearance structure according to the present disclosure;

FIG. 5 is a second schematic diagram of an appearance structure according to the present disclosure;

FIG. 6 is a first schematic diagram of a structure of a blowing part housing according to the present disclosure; and

FIG. 7 is a second schematic diagram of a structure of a blowing part housing according to the present disclosure.

In the figures: 1 blowing part; 11 refrigeration device; 111 conducting member; 112 thermoelectric semiconductor; 113 mounting bracket; 114 heat dissipating member; 12 modeling decorative surface shell; 13 atomization plate; 14 housing; 141 air duct; 142 blowing part shell; 143 water storage tank; 144 fan blade base; 145 air guide blade; 146 electrical base; 147 wiring channel; 148 water tank packaging plate; 1481 atomization plate base; 149 water injection port; 1491 water port cover; 15 driving fan blade assembly; 16 air inlet cover; 2 holding part; 21 handle inner shell; 22 handle outer shell; 23 circuit board assembly; 231 control button; 232 power interface; 24 storage battery.

### DETAILED DESCRIPTION OF THE EMBODIMENTS

The technical solution in the embodiment of the present disclosure will be described clearly and completely with reference to the drawings in the embodiment of the present disclosure. Obviously, the described embodiments are only some of the embodiments of the present disclosure, rather than all of the embodiments. Based on the embodiment of the present disclosure, all other embodiments obtained by those skilled in the art without paying creative labor belong to the scope of protection of the present disclosure.

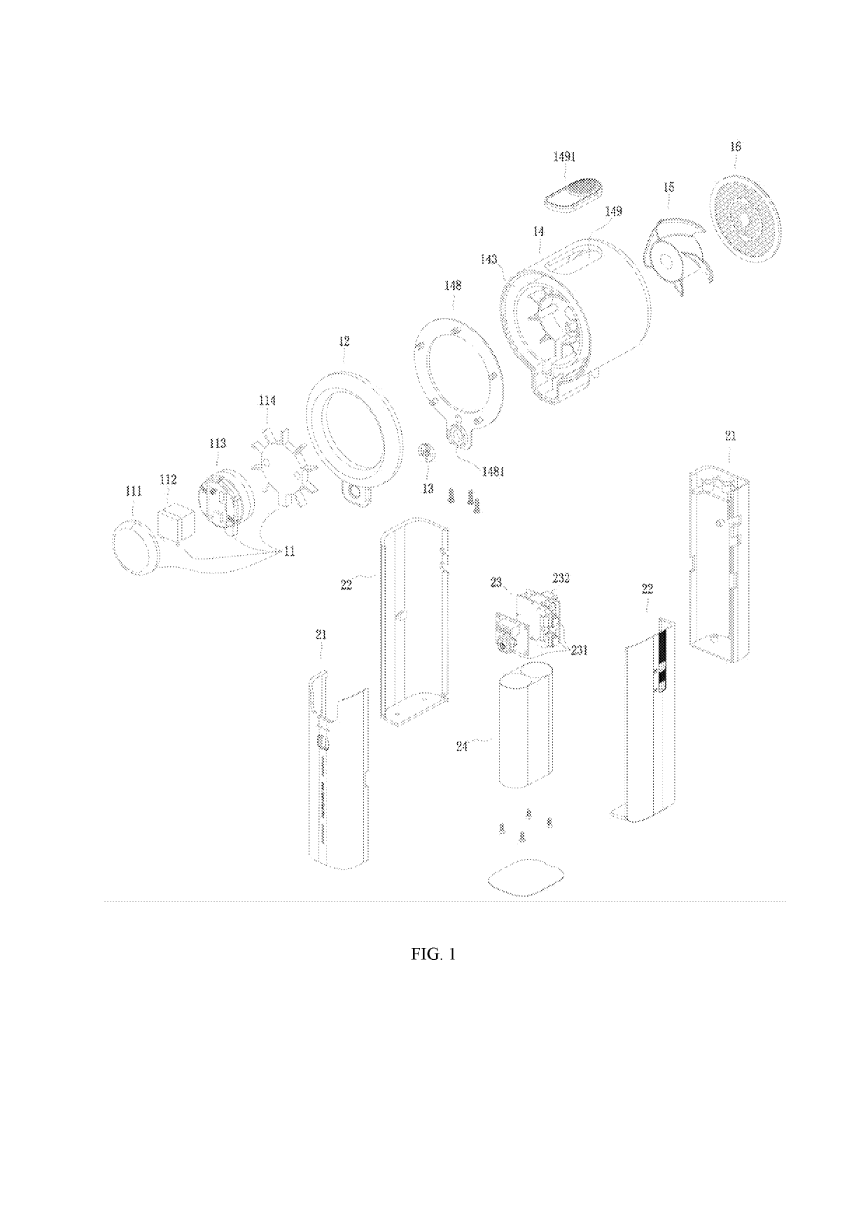

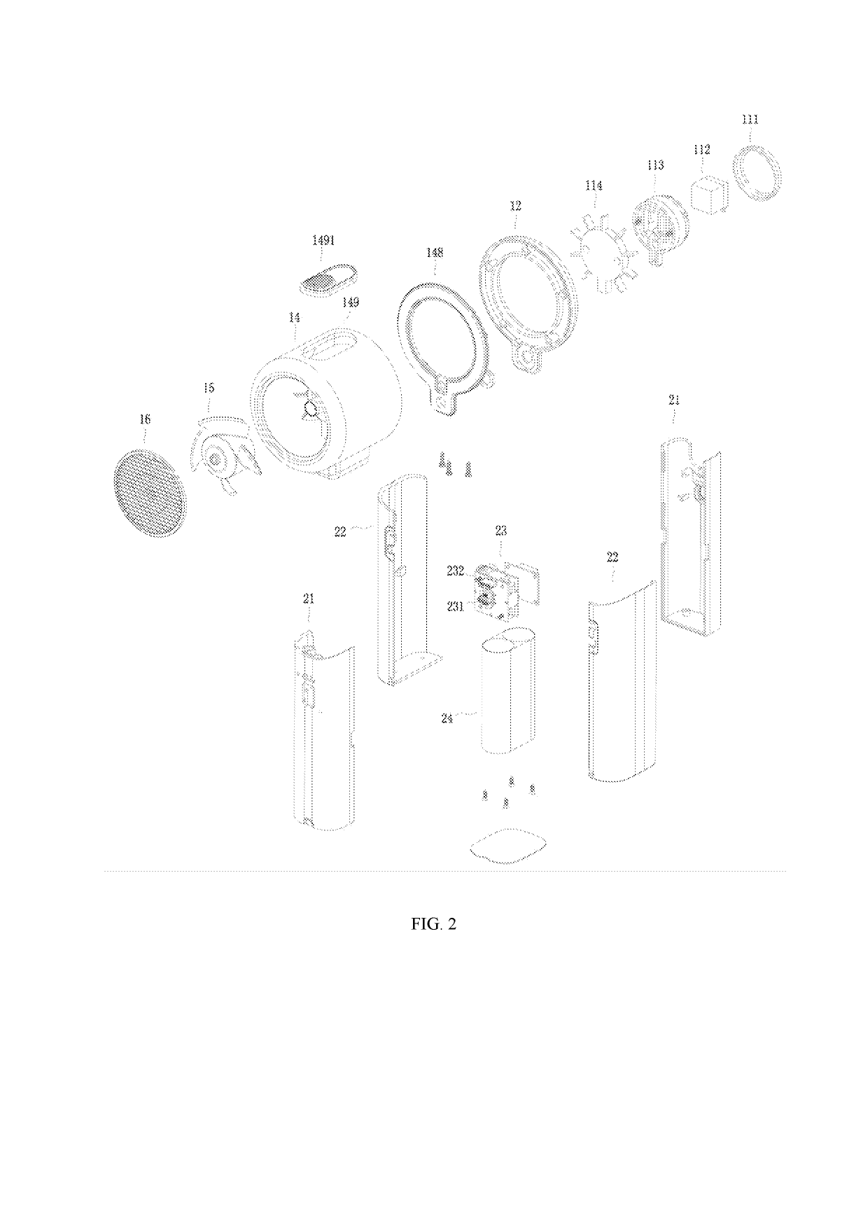

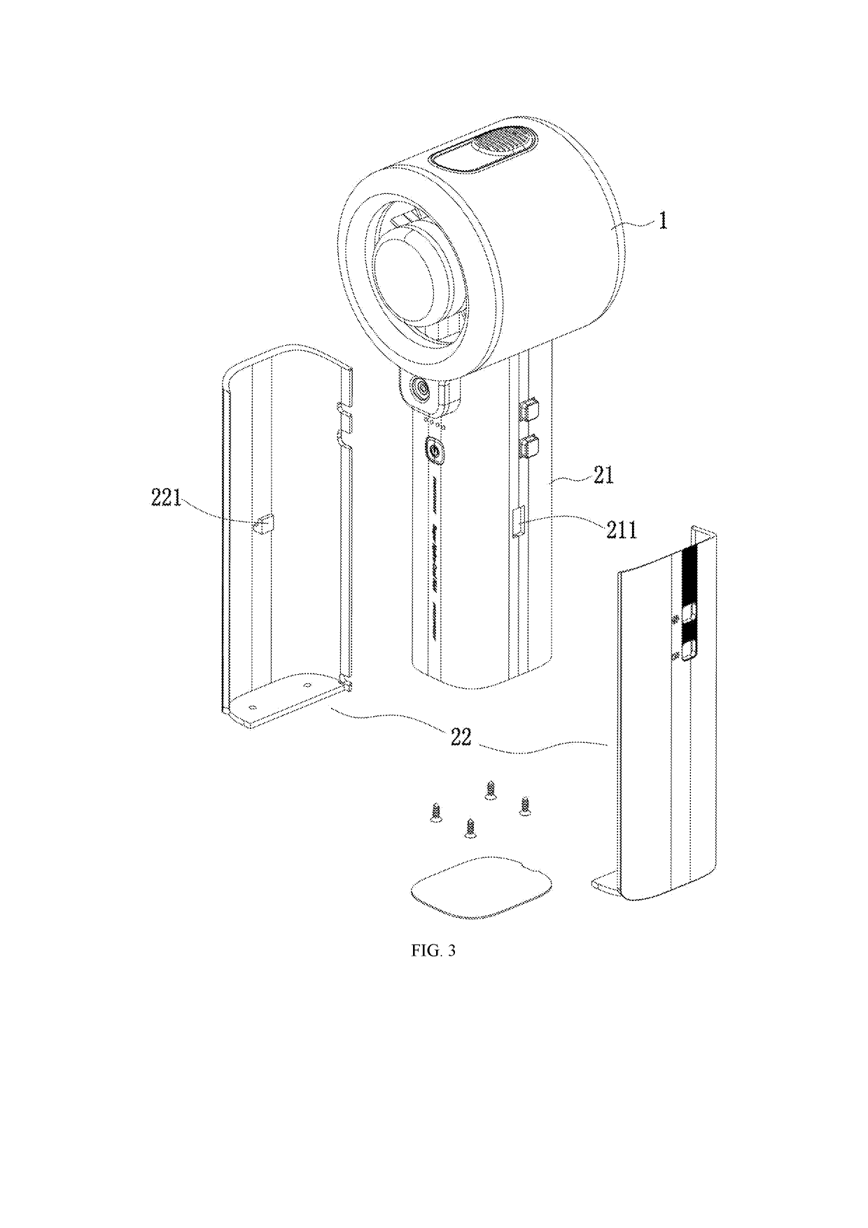

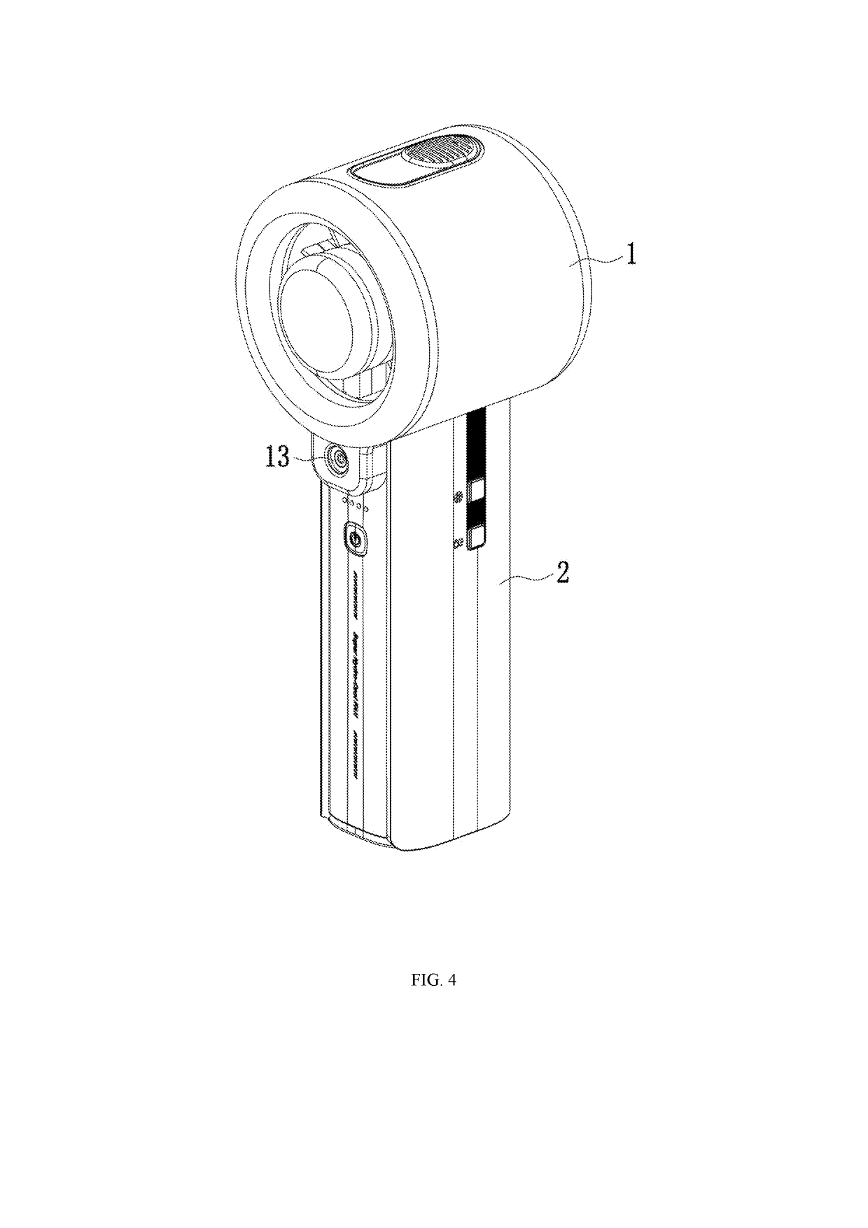

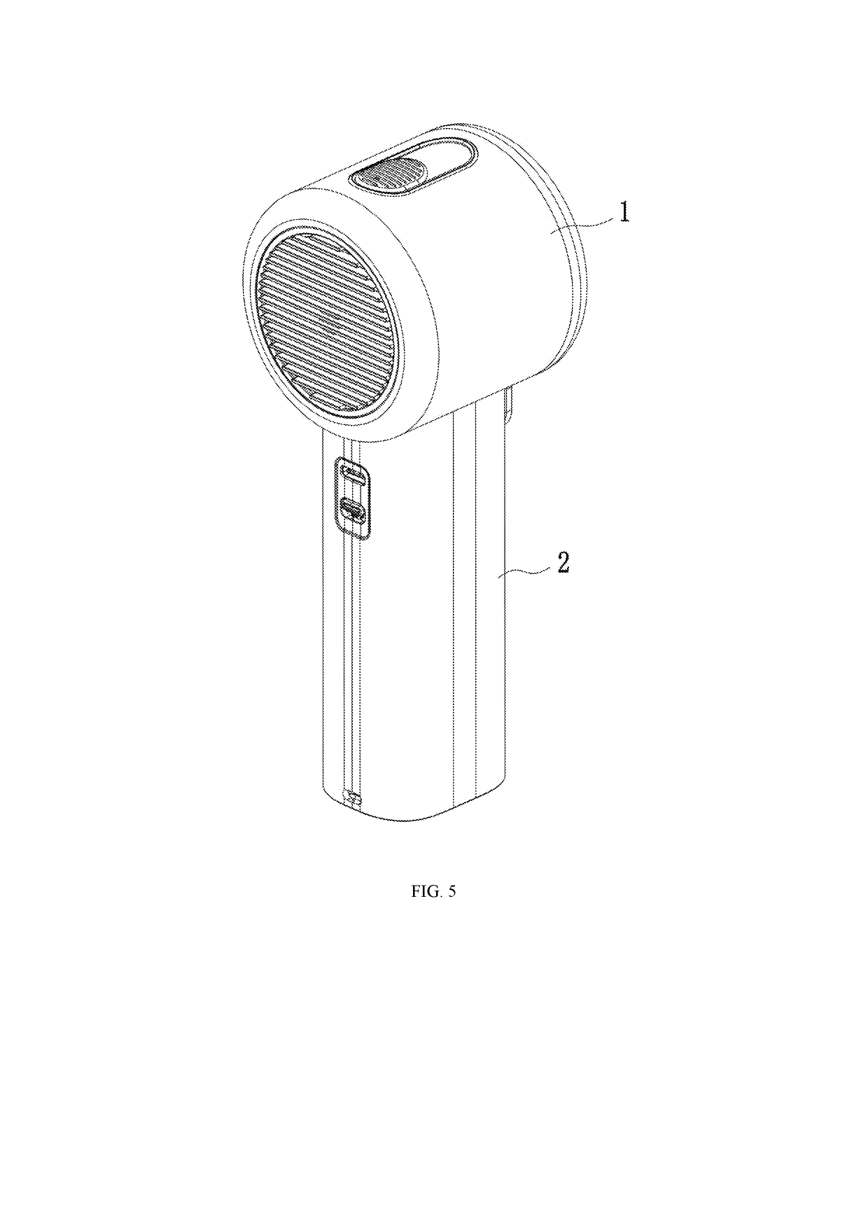

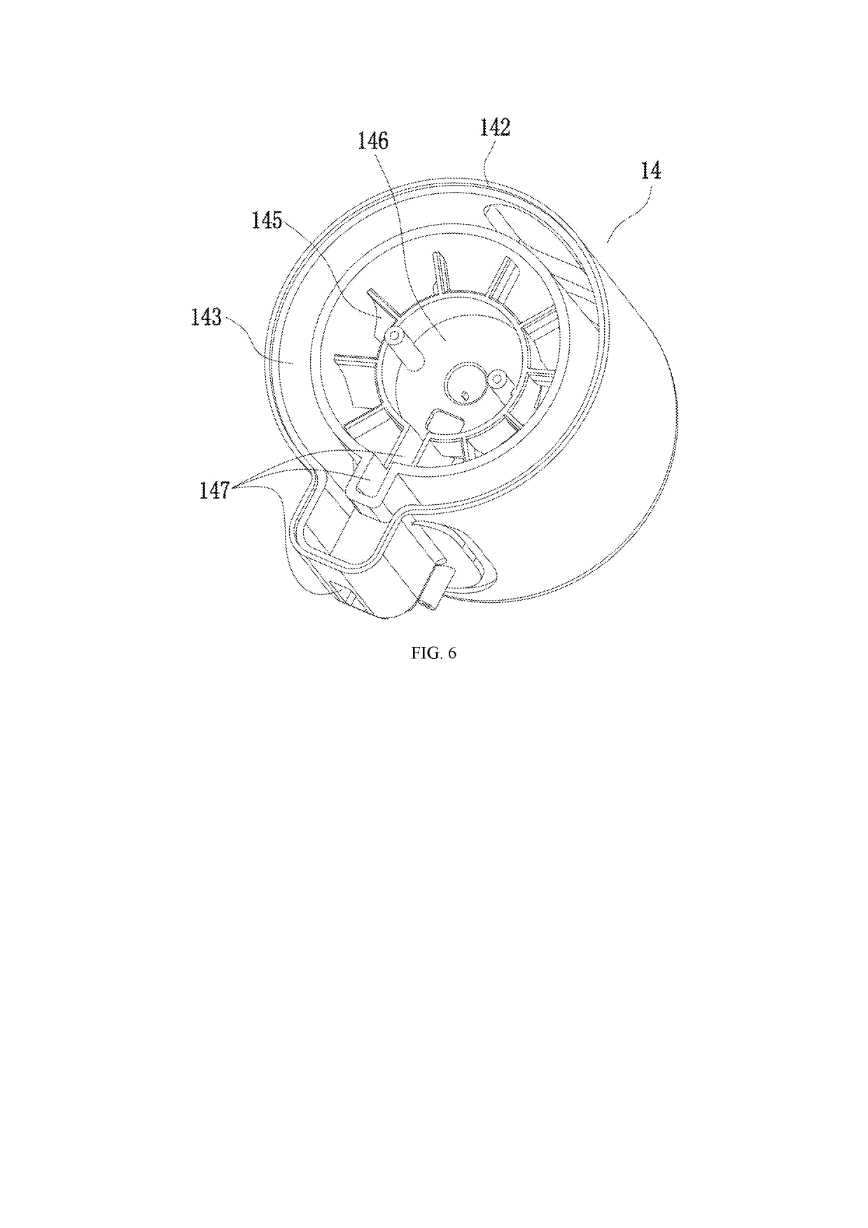

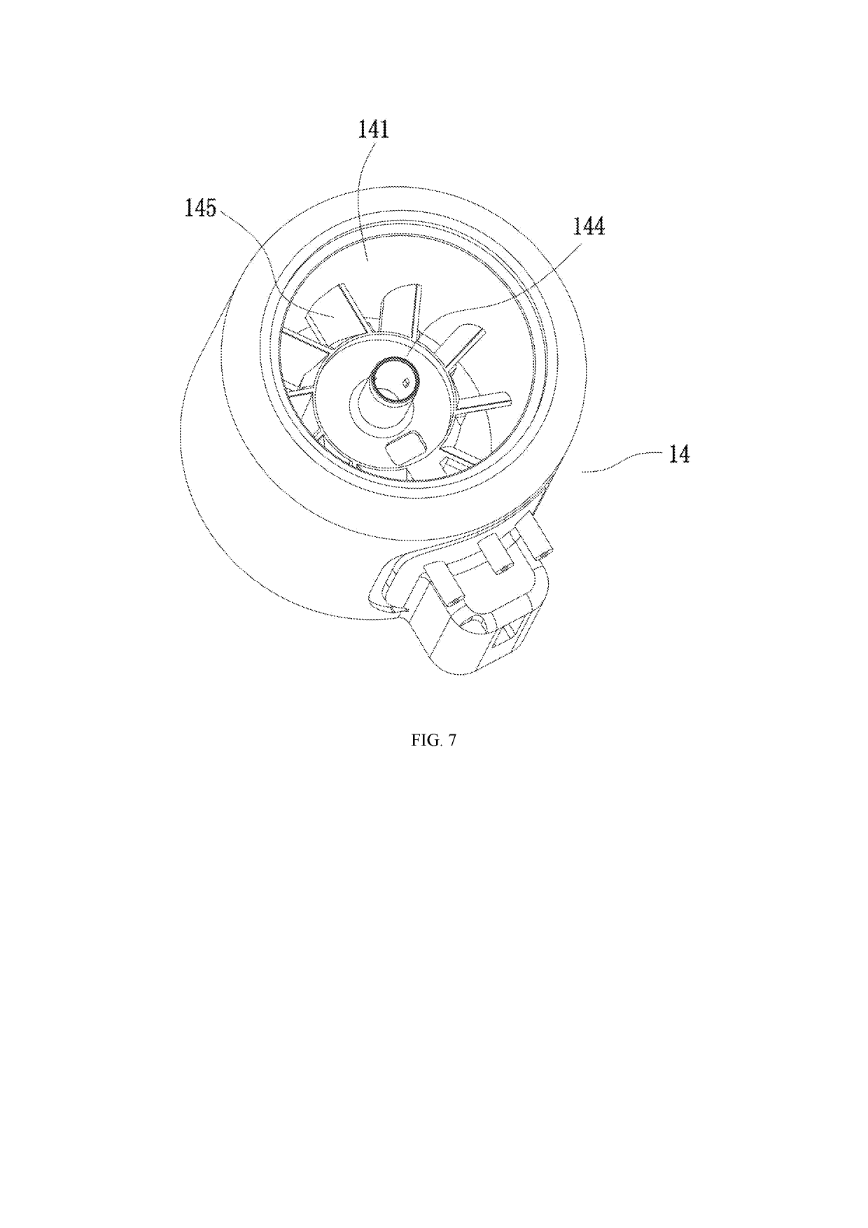

Refer to FIG. 1 to FIG. 7. A spray refrigeration fan includes a blowing part 1. The blowing part 1 includes an air duct 141. Two ends of the air duct 141 are arranged as an air inlet and an air outlet, respectively. A water storage tank 143 is arranged around a circumferential wall surface of the air duct 141. A lower end of the water storage tank 143 is provided with an atomization plate base 1481. The atomization plate base 1481 is communicated with an interior of the water storage tank 143. The atomization plate base 1481 is provided with an atomization plate 13. Water in the water storage tank 143 is converted into water mist and sprayed outward by the atomization plate 13.

The blowing part 1 includes a housing 14. The housing 14 includes a tubular air duct 141. Two ends of the air duct 141 are arranged as a first end and a second end, respectively. An edge of the second end of the air duct 141 is turned over 180 degrees toward a circumferential outer side of the air duct 141 and then extends along a length direction of the air duct 141 to form a blowing part shell 142. The water storage tank 143 is formed between the blowing part shell 142 and an outer wall surface of the air duct 141. The water storage tank 143 includes a water tank packaging plate 148 covered at the first end. The blowing part shell 142 and the air duct 141 form a clamping opening at the first end. The water tank packaging plate 148 is packaged on the clamping opening, so that the water storage tank 143 forms a container structure capable of containing liquid water. The atomization plate base 1481 is arranged on the water tank packaging plate 148. This structure facilitates injection molding of the housing 14. The housing 14 can be formed in one step via a mold during injection molding production, thereby reducing mold investment costs and processing procedures of the mold.

An outer side of the water tank packaging plate 148 is covered with a modeling decorative surface shell 12. The modeling decorative surface shell 12 is used to help shape the overall appearance of the fan, so that the appearance is more beautiful.

A wall surface of the water storage tank 143 is provided with a water injection port 149, and the water injection port 149 is movably covered with a water port cover 1491. The water injection port 149 is used for users to inject water into the water storage tank 143. The water port cover 1491 is optionally provided with ventilation holes. The atomization plate 13 may continuously consume water in the water storage tank 143 in an operating process. Without ventilation holes, as the amount of water in the water storage tank 143 decreases, a negative air pressure in the water storage tank 143 may increase. When the negative air pressure in the water storage tank 143 reaches a specific level, it is difficult for liquid water to reach the atomization plate 13 for use when the atomization plate 13 operates, resulting in a phenomenon that the atomization plate 13 stops spraying.

A fan blade base 144 is arranged in the air duct 141. The fan blade base 144 is arranged toward an air inlet side. The air inlet is covered with a hollow air inlet cover 16. A part of a body on a circumferential wall surface of the fan blade base 144 radially extends to form an air guide blade 145. One end that is of the air guide blade 145 and that is far away from the fan blade base 144 is connected with an inner wall surface of the air duct 141. A driving fan blade assembly 15 is mounted on the fan blade base 144. The driving fan blade assembly 15 guides air flow at the air inlet to flow through the air duct 141 and then to be blown outward from the air outlet. The air guide blade 145 can comb air flow passing through the air guide blade 145 by its own shape, thereby optimizing characteristics of the air flow. For example, a pressurization effect can be achieved by reducing an air passage cross-section. The air flow can also be guided, so that the air flow is blown outward in a direction parallel to the air outlet, thereby increasing a blowing distance and a utilization rate of the air flow. An electrical base 146 is arranged on one side that is of the fan blade base 144 and that faces away from the driving fan blade assembly 15. The blowing part 1 is provided with a wiring channel 147. The wiring channel 147 is communicated with the electrical base 146 and an outer space of the blowing part 1. In this embodiment, a lower end of the blowing part is integrally connected with a holding part 2. A circuit board assembly 23 is arranged in the holding part 2. A refrigeration device 11 in the blowing part 1 and the driving fan blade assembly 15 can be electrically connected with the circuit board assembly 23 in the holding part 2 through the wiring channel 147.

A refrigeration device 11 is mounted on the electrical base 146. The refrigeration device 11 includes a conducting member 111, a thermoelectric semiconductor 112, and a heat dissipating member 114. The heat dissipating member 114 is fixedly arranged on the electrical base 146 through a mounting bracket 113. The thermoelectric semiconductor 112 is fixedly arranged on the mounting bracket 113. The conducting member 111 is mounted on one side that is of the thermoelectric semiconductor 112 and that faces away from the heat dissipating member 114. The thermoelectric semiconductor 112 includes a heating end and a cooling end. The heating end is in heat conduction connection with the heat dissipating member 114. The cooling end is in heat conduction connection with the conducting member 111. The heat dissipating member 114 is an aluminum alloy member. The conducting member 111 is a steel metal member. The refrigeration device 11 is arranged, so that the body of the fan has a cold compress care function. The conducting member 111 can be cooled by operation of the thermoelectric semiconductor 112, and then cold compress physiotherapy can be performed on a human body by the low-temperature conducting member 111.

A lower end of the blowing part 1 is connected with a holding part 2. The holding part 2 includes a holding housing. An accommodating cavity is formed in the holding housing. A circuit board assembly 23 and a storage battery 24 are arranged in the accommodating cavity. The storage battery 24 is electrically connected with the circuit board assembly 23. The circuit board assembly 23 is electrically connected with a control button 231 and a power interface 232. Both the control button 231 and the power interface 232 are arranged in a preset through hole of the holding housing and extend outward from the through hole. The control button 231 is used to adjust the operating state and the operating mode of the refrigeration device 11 and the driving fan blade assembly 15. The power interface 232 can be optionally a Type-C interface. When the power interface 232 is connected with an external power supply by a charging cable, the storage battery 24 can be charged to replenish the electric quantity of the storage battery 24.

The holding housing includes handle inner shells 21 and handle outer shells 22. Two handle inner shells 21 are arranged. The two handle inner shells 21 are located at a front side and a rear side, respectively, to cover and connect with each other to form the accommodating cavity. Two handle outer shells 22 are arranged. The two handle outer shells are buckled on a left side and a right side of the handle inner shell 21, respectively. A wall surface of the handle inner shell 21 is provided with a buckling hole 211. An inner wall surface of the handle outer shell 22 is provided with a buckling claw 221 corresponding to the buckling hole 211. The handle outer shell 22 is buckled on the buckling hole 211 through the buckling claw 221 to be integrally connected with the handle inner shell 21. This structural cooperation is beneficial to simplifying the assembly process and improving the assembly efficiency. At the same time, the dual-shell structure can enrich the design and improve the aesthetic appearance and the three-dimensional effect of the product.

To sum up, according to the spray refrigeration fan, the water storage tank 143 is skillfully arranged around the air duct 141 in a circumferential direction, thereby arranging a large-capacity water tank, meeting an atomization water demand of an atomization device, and also effectively avoiding an adverse effect of the large-capacity water tank on appearance and portability of a product. In addition, a refrigeration device 11 can also add a cold compress care function to the fan, thereby greatly improving practicability of the fan.

It should be noted that in the present disclosure, relational terms such as first and second are only used to distinguish one entity or operation from another entity or operation, and do not necessarily require or imply that there is any such actual relationship or order between these entities or operations. Moreover, terms "including", "containing" or any other variation thereof are intended to cover non-exclusive inclusion, so that a process, method, article or device including a series of elements includes not only those elements, but also other elements not explicitly listed or elements inherent to such a process, method, article or device.

Although the embodiments of the present disclosure have been shown and described, it may be understood by those skilled in the art that many changes, modifications, substitutions, and variations can be made to these embodiments without departing from the principle and spirit of the present disclosure, and the scope of the present disclosure is defined by the appended claims and their equivalents.

What is claimed is:

1. A spray refrigeration fan, comprising a blowing part (1), wherein the blowing part (1) comprises an air duct (141), two ends of the air duct (141) are arranged as an air inlet and an air outlet, respectively, a water storage tank (143) is arranged around a circumferential wall surface of the air duct (141), a lower end of the water storage tank (143) is provided with an atomization plate base (1481), the atomization plate base (1481) is communicated with an interior of the water storage tank (143), the atomization plate base (1481) is provided with an atomization plate (13), and water in the water storage tank (143) is converted into water mist and sprayed outward by the atomization plate (13).

2. The spray refrigeration fan according to claim 1, wherein the blowing part (1) comprises a housing (14), the housing (14) comprises a tubular air duct (141), two ends of the air duct (141) are arranged as a first end and a second end, respectively, an edge of the second end of the air duct (141) is turned over 180 degrees toward a circumferential outer side of the air duct (141) and then extends along a length direction of the air duct (141) to form a blowing part shell (142), the water storage tank (143) is formed between the blowing part shell (142) and an outer wall surface of the air duct (141), and the water storage tank (143) comprises a water tank packaging plate (148) covered at the first end.

3. The spray refrigeration fan according to claim 2, wherein an outer side of the water tank packaging plate (148) is covered with a modeling decorative surface shell (12).

4. The spray refrigeration fan according to claim 1, wherein a wall surface of the water storage tank (143) is provided with a water injection port (149), and the water injection port (149) is movably covered with a water port cover (1491).

5. The spray refrigeration fan according to claim 1, wherein a fan blade base (144) is arranged in the air duct (141), the fan blade base (144) is arranged toward an air inlet side, a part of a body on a circumferential wall surface of the fan blade base (144) radially extends to form an air guide blade (145), one end that is of the air guide blade (145) and that is far away from the fan blade base (144) is connected with an inner wall surface of the air duct (141), a driving fan blade assembly (15) is mounted on the fan blade base (144), the driving fan blade assembly (15) guides air flow at the air inlet to flow through the air duct (141) and then to be blown outward from the air outlet, an electrical base (146) is arranged on one side that is of the fan blade base (144) and that faces away from the driving fan blade assembly (15), the blowing part (1) is provided with a wiring channel (147), and the wiring channel (147) is communicated with the electrical base (146) and an outer space of the blowing part (1).

6. The spray refrigeration fan according to claim 5, wherein a refrigeration device (11) is mounted on the electrical base (146), the refrigeration device (11) comprises a conducting member (111), a thermoelectric semiconductor (112), and a heat dissipating member (114), the heat dissipating member (114) is fixedly arranged on the electrical base (146) through a mounting bracket (113), the thermoelectric semiconductor (112) is fixedly arranged on the mounting bracket (113), the conducting member (111) is mounted on one side that is of the thermoelectric semiconductor (112) and that faces away from the heat dissipating member (114), the thermoelectric semiconductor (112) comprises a heating end and a cooling end, the heating end is in heat conduction connection with the heat dissipating member (114), and the cooling end is in heat conduction connection with the conducting member (111).

7. The spray refrigeration fan according to claim 6, wherein the heat dissipating member (114) is an aluminum alloy member, and the conducting member (111) is a steel metal member.

8. The spray refrigeration fan according to claim 1, wherein a lower end of the blowing part (1) is connected with a holding part (2), the holding part (2) comprises a holding housing, an accommodating cavity is formed in the holding housing, a circuit board assembly (23) and a storage battery (24) are arranged in the accommodating cavity, the storage battery (24) is electrically connected with the circuit board assembly (23), the circuit board assembly (23) is electrically connected with a control button (231) and a power interface (232), and both the control button (231) and the power interface (232) are arranged in a preset through hole of the holding housing and extend outward from the through hole.

9. The spray refrigeration fan according to claim 8, wherein the holding housing comprises handle inner shells (21) and handle outer shells (22), two handle inner shells (21) are arranged, the two handle inner shells (21) are located at a front side and a rear side, respectively, to cover and connect with each other to form the accommodating cavity, two handle outer shells (22) are arranged, the two handle outer shells are buckled on a left side and a right side of the handle inner shell (21), respectively, a wall surface of the handle inner shell (21) is provided with a buckling hole (211), an inner wall surface of the handle outer shell (22) is provided with a buckling claw (221) corresponding to the buckling hole (211), and the handle outer shell (22) is buckled on the buckling hole (211) through the buckling claw (221) to be integrally connected with the handle inner shell (21).

10. The spray refrigeration fan according to claim 1, wherein the air inlet is covered with a hollow air inlet cover (16).
